(19) United States
(12) Patent Application Publication
(10) Pub. No.: US 2003/0084307 A1
(43) Pub. Date: May 1, 2003

(54) Secure boot device selection method and system

(76) Inventor: Jeffrey D. Schwartz, Loveland, CO (US)

Correspondence Address: HEWLETT-PACKARD COMPANY, Intellectual Property Administration, P.O. Box 272400, Fort Collins, CO, 80527-2400, US

(21) Appl. No.: 09/999,123

(22) Filed: Oct. 30, 2001

(51) Int. Cl. G06F 12/14

(52) U.S. Cl. 713/189

(57) ABSTRACT

An embodiment of a secure boot device selection method retrieves a device identifier from an isolated storage medium, selects one of a plurality of devices to boot in response to the device identifier, and boots one of the plurality of devices.

Another embodiment of a secure boot device selection system comprises a memory accessible through execution by a processor of a basic input/output system (BIOS) application and an operating system application, and a plurality of boot devices having an assigned device identifier associated with the boot device and stored in the memory. The BIOS application is executable by the processor and adapted to access the memory, adapted to retrieve the device identifier, select one of the plurality of boot devices to boot in response to the device identifier, and boot one of the plurality of boot devices.

### RELATED APPLICATIONS

This application is related to co-pending U.S. patent application Ser. No. ______ entitled Appliance Security Model System and Method, filed on even date herewith.

This application is also related to co-pending U.S. patent application Ser. No. ______ entitled System and Method for Securing a Computer, filed on even date herewith.

### TECHNICAL FIELD OF THE INVENTION

The present invention relates generally to the field of computer processing systems and, more particularly, to a boot device selection method and system.

### BACKGROUND OF THE INVENTION

Security has become an increasingly important concept to computer system users and thus to manufacturers of both hardware and software. Mechanisms to ensure security include software-based methods such as utilizing passwords, administrative codes and other user-provided security codes to protect data from unauthorized access. In addition, computer systems also may include hardware-based mechanisms to provide security, such as computer control codes.

For example, computer systems typically include hardware such as a motherboard, which has a processor, memory, and other functional components. These systems also usually include a hard drive for storing data such as applications, system files, and data files containing word processing documents, audio, video, and other data. Computer systems are also typically equipped with basic input/output system-(BIOS)-based passwords. A BIOS-based password program runs before computer control is relinquished to any disk-based software application. In order to access data on the hard drive, a BIOS-based encryption key and/or password is typically required.

Execution of the BIOS is required to boot the hard drive, a process where an operating system (OS) kernel is loaded into random access memory (RAM) and then executed upon completion of the BIOS execution. Generally, the software that begins the boot process is typically not subject to any authentication. Such a method unfortunately suffers from disadvantages. For example, the computer system may be booted by software program that has not been authenticated.

Standard PC security models have been used as a basis for security models for appliances. However, these appliance security models suffer from disadvantages. For example, these models typically utilize a single password for all appliances. Thus, once broken, all of the appliances are accessible by unauthorized users. However, development of new security models for appliances that are not based on those of PCs imposes training and development burdens for manufacturers. Fore example, service personnel must be trained on a new security model that differs from those of standard PCs in order to service the unit (e.g., service personnel typically enter in a root password to allow them access to, and authority to alter, file systems on the PC). Furthermore, developers must develop the new security model and make it operational for the PC.

### SUMMARY OF THE INVENTION

From the foregoing, it may be appreciated that a need has arisen for providing a method for selecting one of a plurality of boot devices to be booted, as desired. In accordance with the present invention, a boot device selection system and method are provided that substantially eliminate or reduce disadvantages and problems of conventional systems.

An embodiment of a secure boot device selection method retrieves a device identifier from an isolated storage medium, selects one of a plurality of devices to boot in response to the device identifier, and boots one of the plurality of devices.

Another embodiment of a secure boot device selection system comprises a memory accessible through execution by a processor of a basic input/output system (BIOS) application and an operating system application, and a plurality of boot devices having an assigned device identifier associated with the boot device and stored in the memory. The BIOS application is executable by the processor and adapted to access the memory, adapted to retrieve the device identifier, select one of the plurality of boot devices to boot in response to the device identifier, and boot one of the plurality of boot devices.

Another embodiment of a secure boot device selection application comprises a basic input/output system (BIOS) application resident in a computer-readable medium and further adapted to access a memory accessible through execution of the BIOS application and an operating system application, by a processor. The BIOS application is also adapted to retrieve a device identifier, select one of the plurality of boot devices to boot in response to the device identifier, and boot one of the plurality of boot devices.

### BRIEF DESCRIPTION OF THE DRAWINGS

FIG. 1 is a block diagram of an embodiment of a secure boot device selection system utilizing teachings of the present invention; and

FIG. 2 is an example of a method that may be used for secure boot device selection utilizing teachings of the present invention.

### DETAILED DESCRIPTION OF THE DRAWINGS

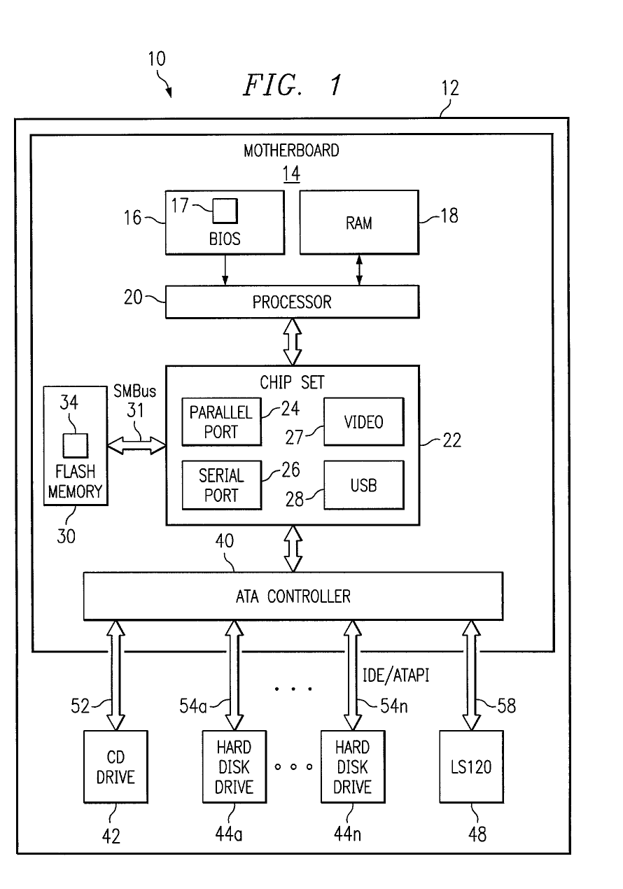

FIG. 1 is a block diagram illustrating an embodiment of a security system 10 utilizing teachings of the present invention. In that embodiment, security system 10 includes an appliance 12 that has a motherboard 14. Motherboard 14 includes a variety of computer-related components that may be found in a representative computer-type device. The present invention contemplates a variety of other representative configurations, whether conventional or non-conventional, and whether now known or developed in the future. Appliance 12 may be one of a variety of devices such as, without limitation, a hand-held or stationary device for accessing a network such as the Internet, and devices such as desktop personal computers (PCs), notebook computers, personal digital assistants, and other computing devices.

Systems and methods employing the teachings of the present invention may reduce or eliminate problems encountered with conventional systems that usually attempt to boot drive devices in a listed order. With conventional systems, processor 20 begins by attempting to boot devices in a given order during execution of power-on self-test module and/or other BIOS applications 17, and after the list of available boot devices coupled to motherboard 14 is exhausted, the system will halt. Although each drive device may contain a different operating system, generally only one of the drive devices will be booted. If all boot devices fail, system 10 may not be booted. Further, an unauthorized user using such a system could insert an unauthorized OS contained on a CD into CD drive 42. System 10 would then attempt to boot this unauthorized OS using this CD, which could override the default order used in a traditional system. The unauthorized OS and/or software applications contained on the booted CD could then be used to alter the software in system 10, thereby reducing or even eliminating the integrity of system 10.

System 10 provides a method for secure boot drive selection that may substantially reduce or eliminate problems that would otherwise be encountered with conventional systems. For example, system 10 provides for the use of a device identifier to be located in an isolated memory available to both BIOS and OS, where it may remain intact. This scenario prevents defaults that may be set by a system reset from reverting to those values in the BIOS default list that would otherwise occur with conventional systems. The device identifier may be retrieved by the BIOS and used to determine which of a plurality of boot devices, a total of n+3 as illustrated in FIG. 1, may be used as a first boot device. A plurality of boot devices may be available, or may be stored using a variety of methods such as a list in, for example, a battery-operated random access memory (RAM), which is non-volatile memory, flash memory 30, or RAM 18. This memory retains parameters for BIOS 16, and is separate from RAM used by processor 20. BIOS 16 may retain default parameter changes through any number of boot cycles. In a particular embodiment, if the device identifier has a desired value, such as two, a boot device identified by that desired value is attempted first. For example, a second boot device in a list is attempted first where the device identifier has the value two. In a particular embodiment, the method may boot a boot device in an order in a list is where the device identifier differs from its position in the list, depending on the implementation. Also in a particular embodiment, if the device identifier is associated with a device that is not bootable, the BIOS may prompt for additional security mechanisms, such as a user password, before proceeding with the first item on the list. This provides a means to secure a computer system from being booted by software that has not been authenticated. Moreover, this method allows service personnel the flexibility to treat the unit as a PC, while maintaining such security.

Motherboard 14 includes a processor 20 coupled to a flash memory basic input/output system (BIOS) 16 and a RAM 18. BIOS 16 includes a power-on self-test module and other applications 17 for performing system initialization, tests, and execution of a secure boot device selection method. Motherboard 14 also includes an interface chipset 22 for communicating with input-output devices such as, but not limited to, a mouse, a keyboard, a scanner, a printer, or a display device such as a monitor (not explicitly shown). In this embodiment, interface chipset 22 includes a parallel port 24, serial port 26, video port 27, and a universal serial bus (USB) 28 to communicate with the various input/output devices. Motherboard 14 also includes a flash memory 30. In a particular embodiment, flash memory 30 may be a serial flash memory coupled to interface chipset 22 via a System Management Bus SMBus 31. Flash memory 30 is accessible by a BIOS application 17 and applications of the OS.

Appliance 12 may be coupled via motherboard 14 to a variety of boot devices using a variety of interfaces for reading and/or storing data. For example, in the embodiment illustrated in FIG. 1, motherboard 14 may be coupled to one or more CD drives 42, each coupled via an integrated device electronics/advanced technology attachment packet interface (IDE/ATAPI) bus 52. CD drive 42 may be used to read or store data such as an operating system and various other application modules or routines that may be used to boot appliance 12 in certain scenarios. Motherboard 14 may also be coupled to one or more hard disk drives 44a, . . . ,44n via busses 54a, . . . ,54n. Motherboard 14 may also be coupled to various other drive storage devices such as, but not limited to, LS-120 drive 48 via bus 58 and other drives such as floppy disk drives (not explicitly shown). Such an arrangement may allow appliance 12 to be used in a variety of applications using different operating systems, as desired. Each of these boot devices may include, or be loaded with, media that includes a unique operating system such as LINUX, UNIX, MAC-OS, WINDOWS, or other operating systems, and various other application modules or routines that may be used with the particular operating system.

Briefly, a device identifier 34 associated with each of devices 42, 44a, . . .,44n, and 48 may be stored in flash memory 30. In a particular embodiment, device identifier 34 may have a value that represents a position of one of devices 42, 44a, . . . ,44n, and 48 in a list. Device identifier 34 may be preprogrammed into flash memory 30 during the load of software of system 10. During execution of the poweron self-test module 17, BIOS 16 uses device identifier 34 to identify which of the devices to use to boot system 10. BIOS 16 proceeds to boot, for example, an identified hard drive and load an operating system or other software application from the hard drive. If the identified device is not a bootable device, BIOS 16 does not boot the unbootable device. BIOS 16 then may, in a particular embodiment, request a password for authentication before attempting a boot for each device in the list until a boot is successful. In a particular embodiment, this password associated with the identified device may be stored in flash memory 30, and retrieved while attempting to boot the indicated drive device.

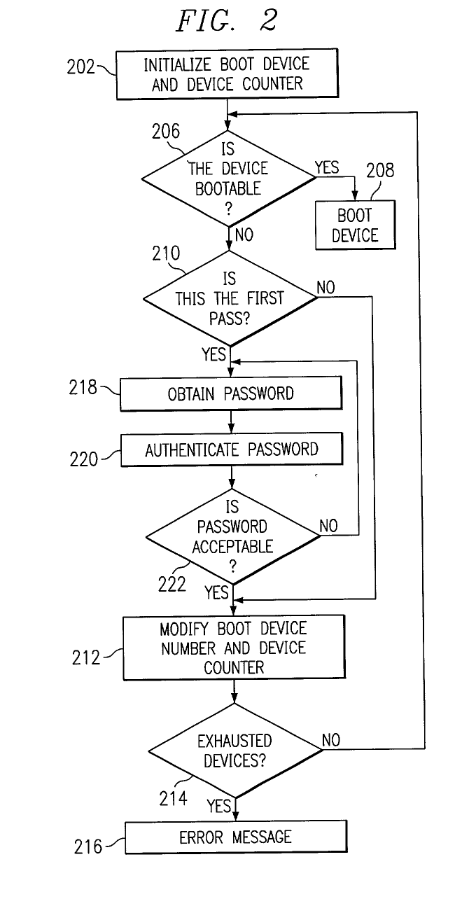

FIG. 2 is an example of a method that may be used to provide secure boot device selection utilizing teachings of the present invention. The method begins at step 202, where the method initializes a boot device number and a device counter. The boot device may be initialized using a variety of methods. For example, an initial boot device may be set to a default device such as one of hard disk drives 44a, . . . ,44n. A device counter may be used in a particular embodiment to, for example, facilitate the method progressing through a plurality of devices. The method then uses the boot device number or device identifier 34 to select which device to boot. System 10 then selects to boot using one of devices 42, 44a, . . . ,44n, and 48 as identified by device identifier 34. Devices identified by device identifier 34 may, in a particular embodiment, be stored in a list, and may be identified by device identifier 34 having a value corresponding to the order of the devices in the list. The value for device identifier 34 may be identified by retrieving a value that may be stored in serial flash memory 30. In a particular embodiment, the boot device number and device counters may be initialized with particular values. For example, a preferred boot device may be one of the hard drives 44a, . . . ,44n. In this example, one of these drives may be in a particular position in the list (e.g., such as the second item). In this case, the device number may be initialized to two, and the device counter set to a value of one.

In step 206, the method attempts to boot the device identified by device identifier 34. In a particular embodiment, if the device may not be booted, the device is booted in step 208, and the method ends. If the device did not boot in step 206, the method may generate an error message. In this scenario, system 10 may generate a call center service message or other error message. The method then proceeds to step 210, where it queries whether this is a first pass through the method. If not, the method modifies the device counter and boot device number in step 212. Thus, using the example above, the boot device number may be assigned the value of the device counter, and the device counter may be incremented. As an example, after the first pass through the method, the boot device number is assigned the value of one, the device counter is incremented to the value two. Subsequent passes, after the initial pass that attempted to boot the preferred boot device, increment the device counter and boot device number, proceeding to attempt to boot all of the devices in a list in ascending order. Of course, many other methods and variables other than use of a device counter and boot device number for initialization and re-initialization may be used, depending on the application. In step 214, the method queries whether the number of devices has been exhausted. If not, the method returns to step 206 to attempt to boot another boot device. If, on the other hand, the number of devices has been exhausted, the method ends and may generate one or more messages, such as an audio or visual warning to call a service center.

If the method is at the first pass in step 210, the method proceeds to step 218, where it receives a password that may be input by a user attempting to supervise booting of the identified device. In step 220, the password is authenticated. The method proceeds to step 222, where the method queries whether the password is acceptable. If not, the method returns to step 218 to obtain a password. If the password is acceptable in step 222, the method returns to step 212 where the device counter and boot device number are modified (e.g., incremented).

Valid values for device identifier 34 may depend on a particular implementation and/or application for system 10. As one example, these values may be zero, one and two. If the value of device identifier 34 is zero, system 10 may boot devices in a default order from the list, requiring no passwords at any time. If the value of device identifier 34 is one, the order of the list is used. For example, system 10 boots appliance 12 using devices in the order of the list. BIOS 16 retrieves device identifier 34 from serial flash 30 and selects the identified boot device from the boot device list. In a particular embodiment, the list may include a first item CD drive 42, a second item hard drive 44a, and a third item a floppy disk drive. On the other hand, if the value for device parameter is not one, device identifier 34 corresponds to a device identified by the position of the device in the list. For example, if device identifier 34 is two, the boot device is item number two in the list.

Additionally, system 10 may include a preferred or default boot device. In a particular embodiment, preferred or default boot device may be, for example, item number two, which may, as an example, be identified as hard disk drive 42a. When booting hard disk drive 42a fails, system 10 will proceed through the list, beginning with item one, proceeding to item two, and then continuing until item n+3, which corresponds to the number of devices illustrated in FIG. 1. In a particular embodiment, use of a hard disk drive, such as hard disk drive 42a, may be advantageous as a preferred or default boot device for system 10 generally. This scenario may be particularly advantageous because hard disk drives are typically faster than other external media drives, most data is resident on one of the hard disk drive 44a, . . . ,44n, and these drives are not subject to typical security breaches. That is, devices such as CD drive 42 and the floppy disk drive include external media that may be desirable only in situations where hard disk drive 42a is not bootable, such as when hard disk drive 42a is damaged.

Where system 10 is reset, inadvertently or otherwise, the present invention prevents a BIOS default list item from being used. For example, in conventional systems, a BIOS 16 is typically set to use a default boot device identified by a zero, which in many cases is a floppy disk drive or a CD drive 42. Unfortunately, not only might a user have lost the media for such devices that includes an OS to boot system 10, such a method may be subject to security breaches. For example, where an unauthorized user prefers to overwrite or otherwise access system 10, this user need only reset a conventional system 10 by, for example, removing a battery, and then insert media with an unauthorized OS into the default disk drive indicated. The user may then start the conventional system 10 using this unauthorized software. The present invention prevents appliance 12 from being booted by software that has not been authenticated. Moreover, service personnel need not be trained on a new security model that differs from those of standard PCs in order to service the unit. Appliance 12 thus may be operated and managed similarly to a PC. For example, once service personnel enter in a root password to allow them access to, and authority to alter, file systems on appliance 12 using LINUX as its OS, appliance 12 may be operated like a PC.

What is claimed is:

1. A secure boot device selection method, comprising:
retrieving a device identifier from an isolated storage medium;
selecting one of a plurality of devices to boot in response to the device identifier; and
booting one of the plurality of devices.

2. The method of claim 1, further comprising:
receiving a password if the one of the plurality of devices is not bootable; and
attempting to boot at least another one of the plurality of devices in response to the password.

3. The method of claim 1, wherein the isolated storage medium is accessible through execution of an operating system application and a basic input/output system (BIOS) application operable to boot a motherboard using the one of the plurality of devices.

4. The method of claim 1, wherein the one of the plurality of devices is identified with a list.

5. The method of claim 1, wherein the one of the plurality of devices is a preferred device comprising a hard drive.

6. The method of claim 1, wherein the isolated storage medium comprises a serial flash memory.

7. The method of claim 1, further comprising booting the selected one of the plurality of devices.

8. A secure boot selection system comprising:
a memory accessible through execution by a processor of a basic input/output system (BIOS) application and an operating system application;
a plurality of boot devices having an assigned device identifier associated with the boot device and stored in the memory; and
wherein the BIOS application is executable by the processor and adapted to access the memory, and the BIOS application is adapted to retrieve the device identifier, select one of the plurality of boot devices to boot in response to the device identifier, and boot one of the plurality of devices.

9. The system of claim 8, further comprising:
receiving a password if the one of the plurality of boot devices is not bootable; and
attempting to boot at least another one of the plurality of boot devices in response to the password.

10. The system of claim 8, wherein the memory is accessible solely by an operating system and the BIOS application operable to boot a motherboard using the one of the plurality of devices.

11. The system of claim 8, wherein the one of the plurality of boot devices is identified with a list.

12. The system of claim 8, wherein the one of the plurality of boot devices is a preferred device comprising a hard drive.

13. The system of claim 8, wherein the memory comprises a serial flash memory.

14. The system of claim 8, wherein one of the plurality of boot devices is a preferred device comprising a hard drive.

15. The system of claim 8, wherein the application prompts for a security mechanism if the boot device is not bootable.

16. The system of claim 8, wherein the device identifier is a default value.

17. The system of claim 8, wherein the application is further operable to boot the selected one of the plurality of devices.

18. A secure boot selection application comprising:
a basic input/output system (BIOS) application and further adapted to access a memory accessible through execution of the BIOS application and an operating system application by a processor; and
the application adapted to retrieve a device identifier, select one of the plurality of boot devices to boot in response to the device identifier, and boot one of the plurality of devices.

19. The application of claim 18, wherein the BIOS application is further operable to:
receive a password if the one of the plurality of boot devices is not bootable; and
attempt to boot at least another one of the plurality of boot devices in response to receipt of a password.

20. The application of claim 18, wherein the one of the plurality of boot devices is identified with a list.

21. The application of claim 18, wherein the one of the plurality of boot devices is a preferred device comprising a hard drive.

22. The application of claim 18, wherein the BIOS application is further operable to prompt for a security mechanism if the boot device is not bootable.

23. The application of claim 18, wherein the BIOS application is further operable to boot the selected one of the plurality of devices.
